(19) United States
(12) Patent Application Publication
(10) Pub. No.: US 2007/0190317 A1
(43) Pub. Date: Aug. 16, 2007

(54) Anisotropic scattering adhesive member

(75) Inventors: Yasuhiko Motoda, Shizuoka-shi (JP); Kensaku Higashi, Shizuoka-shi (JP)

Correspondence Address: OLIFF & BERRIDGE, PLC, P.O. BOX 19928, ALEXANDRIA, VA, 22320, US

(73) Assignee: TOMOEGAWA CO., LTD., TOKYO (JP)

(21) Appl. No.: 11/702,631

(22) Filed: Feb. 6, 2007

(30) Foreign Application Priority Data
Feb. 14, 2006 (JP) 2006-037280

(51) Int. Cl. B32B 7/12

(52) U.S. Cl. 428/343

(57) ABSTRACT

An anisotropic scattering adhesive member in which the amount of linear transmitted light corresponding to the incident light entering into a resin layer has an incident angle dependence property, and the resin layer has an adhesion property, is provided. The anisotropic scattering adhesive member of the present invention has a resin layer having an adhesion property formed by curing a photo-curable resin composition, the glass transition temperature after the curing of the resin layer is in a range of −85 to 0° C., and the amount of linear transmitted light corresponding to an incident light transmitted through the resin layer varies depending on the incident angle-of the incident light against the resin layer. In addition, refractive indexes of mutually adjacent cured areas formed in the resin layer are different.

### TECHNICAL FIELD

The present invention relates to an anisotropic scattering adhesive member in which an amount of transmitted light varies greatly depending on incident angle, and which exhibits adhesive properties.

### BACKGROUND ART

A member exhibiting light scattering has been conventionally used as a lighting device or as a building material, and recently in displays, in particular, the member has been widely used in Liquid Crystal Displays (LCDs). As mechanisms for exhibiting light scattering of these members, there are scattering by convex and concave parts formed on a surface (surface scattering), scattering by difference of refractive indexes of a matrix resin and a filler dispersed therein (internal scattering), and scattering by both surface scattering and the internal scattering. Generally, the scattering performances of these light scattering members are isotropic; therefore, it is not possible to selectively scatter an incident light beam so as to have a particular incident angle.

However, a light controlling plate which can selectively scatter a particular incident light beam has recently been suggested in Japanese Unexamined Patent Application Publication (hereinafter referred to as Japanese Publication) No. Hei01(1989)-77001, as follows. This light controlling plate, which is a special light diff-using member, is a plastic sheet in which ultraviolet light is irradiated from a certain direction to a resin composition having plural compounds each having at least one photopolymerizable carbon-carbon double bond in molecules thereof, and each having mutually different refraction indexes. The sheet selectively scatters only an incident light beam having a certain angle relative to the sheet.

As a material to produce the light controlling plate, in addition to the above-mentioned “resin composition comprising plural compounds each having at least one photopolymerizable carbon-carbon double bond in molecules thereof and each having mutually different refractive indexes”, compositions including a urethane acrylate oligomer is disclosed in Japanese Publication No. Hei01(1989)-147405, No. Hei01(1989)-147406, and No. Hei02(1990)-54201.

The structure of the light controlling plate is explained in Japanese Publication No. Hei01(1989)-147405, and here, as explained further by using FIG. 2A, flat areas having mutually different refractive indexes containing a line (line B-B) in which a linear light source (not shown) arranged above the light controlling unit during the production process emits on the surface of the light controlling unit and a line parallel to the line B-B, are formed in the structure.

The flat areas having mutually different refractive indexes are formed in the above-mentioned light controlling unit, and furthermore, a light scattering film exhibiting another scattering property by forming pillar structures having high refractive index along the thickness direction, has been suggested (See WO02/097483 and Japanese Publication No. 2003-202415). This light scattering film is formed by irradiating radiation from a certain direction to a polymer film having a certain radiation-sensitive property while putting a predetermined mask on the film, and the inner structure thereof is shown in FIG. 1. In the FIG. 1, fine areas 2 are typically displayed as cylindrical shapes; however, they can be formed into circular, polygonal, or irregular shapes, and their slopes can be changed depending on conditions of masking and irradiation.

The above-mentioned light controlling plate and light scattering film may be used as a building material and in various displays such as LCDs; however, they themselves are not adhesive. Therefore, it is necessary that they be applied via an adhering layer to be used as a construction member. Therefore, since the optical properties of the adhering layer also has effects on the properties of the displays as final products, it is necessary to investigate optimization of optical properties and adhesion properties depending on the composition when it is multiply layered.

Since it is necessary to reduce thickness, weight and cost in the manufacturing processes of various types of displays, a display having a lower number of component parts is desirably selected from among displays having the same functions and the same price. Adhesive films all having the same optical properties are desirable.

### SUMMARY OF THE INVENTION

Based on the above-mentioned conventional techniques, the present invention aims to improve a light scattering member, and an object of the invention is to provide an anisotropic scattering adhesive member in which adhesion property is added to a film having a light scattering property which greatly changes depending on incident angle of incident light.

The anisotropic scattering adhesive member of the present invention has a resin layer which is formed by hardening a photo-curable resin composition containing at least a monomer and/or oligomer having a photo-polymerizable functional group (primary resin component), in which the glass transition temperature of the resin layer after hardening is in a range from −85 to 0° C., and in which the amount of linear transmitted light corresponding to the incident light being transmitted through the resin layer varies depending on the incident angle of the incident light at the resin layer.

The cured areas, which are mutually adjacent, are formed in the resin layer of the anisotropic scattering adhesive member of the present invention and have different refractive indexes.

The resin layer of the anisotropic scattering adhesive member of the present invention has a matrix and specific cured areas formed in the matrix, and the refractive indexes of the matrix and the specific cured areas are different.

The photo-curable resin composition used in the anisotropic scattering adhesive member of the present invention contains a high-refractive index monomer having a photo-polymerizable functional group (secondary resin component).

The adhesive strength of the resin layer of the anisotropic scattering adhesive member of the present invention is in a range from 1 to 30 N/25 mm which is defined as “adhesive strength when peeled at 180 degrees” in the Japanese Industrial Standard (JIS)-Z0237.

Another anisotropic scattering adhesive member of the present invention exhibits properties so that the amount of linear transmitted light has a scattering center axis.

Another anisotropic scattering adhesive member of the present invention includes the resin layer and a transparent body which is disposed at at least one side of the resin layer.

As disclosed in the present invention, by forming areas having mutually different refractive indexes in the resin layer, the anisotropic scattering adhesive member which has large changes in the rate of the amount of linear transmitted light depending on incident angle of the incident light, that is, the incident angle dependence property, and which has adhesive properties, can be obtained.

### BRIEF DESCRIPTION OF DRAWINGS

FIG. 1 is a diagram showing an example of an anisotropic scattering adhesive member of the present invention.

FIG. 2 is a diagram showing an example of an anisotropic scattering adhesive member of the present invention.

FIG. 3 is a diagram showing an evaluating method of the incident angle dependence properties of the amount of the linear transmitted light of the anisotropic scattering adhesive member.

FIG. 4 is a diagram explaining the incident angle dependence property of the amount of linear transmitted light being transmitted through the anisotropic scattering adhesive member of the present invention.

FIG. 5 is a graph showing the relationship of the incident angle and the amount of linear transmitted light in the evaluation of the incident angle dependence property of the amount of linear transmitted light in the anisotropic scattering adhesive member.

FIG. 6 is a graph showing the relationship of the incident angle and the amount of linear transmitted light in the evaluation of the incident angle dependence property of the amount of linear transmitted light in the anisotropic scattering adhesive member.

FIG. 7 is a graph showing an incident angle dependence property of the amount of linear transmitted light of Example 1.

FIG. 8 is a graph showing an incident angle dependence property of the amount of linear transmitted light of Example 2.

FIG. 9 is a graph showing an incident angle dependence property of the amount of linear transmitted light of Example 3.

FIG. 10 is a graph showing an incident angle dependence property of the amount of linear transmitted light of Comparative Example 1.

FIG. 11 is a graph showing an incident angle dependence property of the amount of linear transmitted light of Comparative Example 2.

### EMBODIMENTS OF THE INVENTION

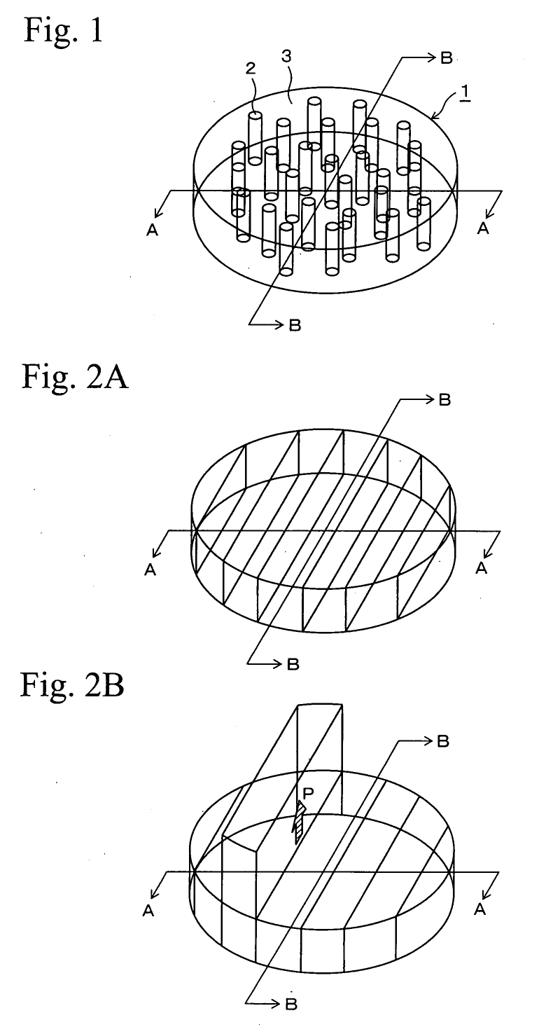

The anisotropic scattering adhesive member of the present invention is further explained. The light scattering property of the anisotropic scattering adhesive member of the present invention has an incident angle dependence property, and the member is adhesive. As shown in FIGS. 1 or 2, the anisotropic scattering adhesive member has a structure in which phases having mutually different refractive indexes are separated.

The anisotropic scattering adhesive member of the present invention is not particularly limited as long as the member has an incident angle dependence property, and in the case of a member in which the specific cured area has a structure of pillar-shaped cured areas 2 formed in the matrix 3 of FIG. 1, the member has a scattering center axis along a direction extending in the pillar-shaped structure. An incident light from a direction near this scattering center axis is greatly scattered (the amount of linear transmitted light is small), and the incident light is scattered somewhat less as the direction of the incident light is inclined relative to the scattering center axis (the amount of linear transmitted light is large). Azimuth angle dependence property is not observed in the inclination from this scattering center axis. On the other hand, in the case of a member having a plate structure as shown in FIG. 2, scattering property similar to that of the member having the structure of FIG. 1 is observed if the incident plane is perpendicular to a direction extending in the plate structure; however, the incident angle dependence property is only slightly observed if the incident plane is a plane including the plate structure.

In FIGS. 1 and 2A, the angle of the normal line direction of the film and a direction in which the axis of the pillar-shaped cured area 2 extends or a direction P having a plate structure which extends are drawn as 0°, and these can be changed arbitrarily, and the angle is desirably not more than 65°, and more desirably not more than 45°. If the angle is more than 65°, it is difficult for the incident angle dependence property to exhibit an asymmetrical property. The reason for this is clear from FIG. 4, in which it can be seen that even if two incident light beams I₁ which are both inclined at the same angle to the incident light beam I₀ parallel to the scattering center axis enter into the anisotropic scattering adhesive member, the length of their light paths in the anisotropic scattering adhesive member differ greatly from each other, and as a result, the light amount corresponding to each transmitted light beam T₁ becomes different.

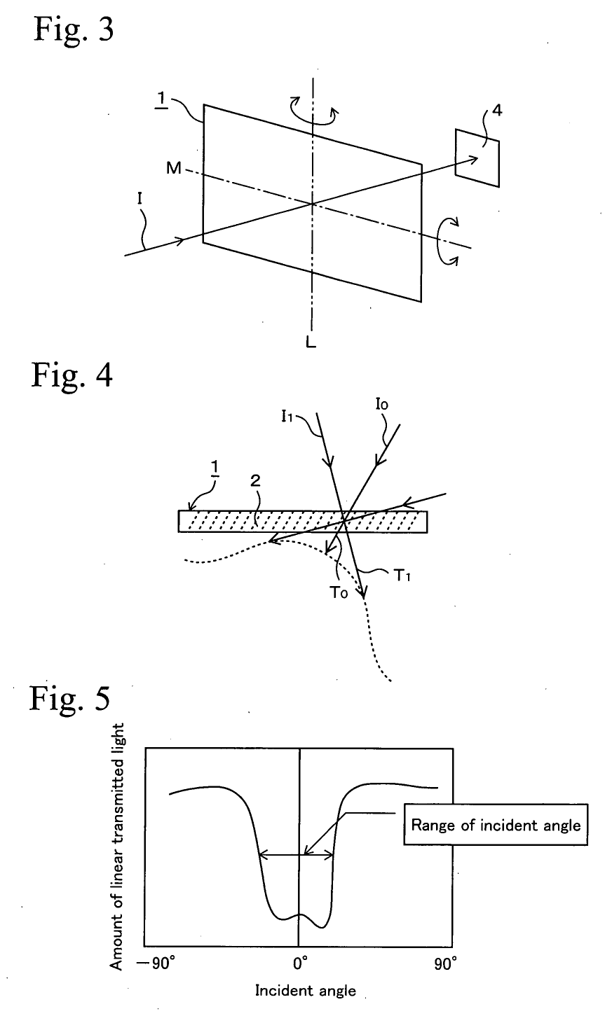

In the present invention, the incident angle dependence property of the light scattering property is expressed by using the amount of linear transmitted light. Generally, the scattering property is expressed by a diffusing transmitting ratio, transmitting ratio of collimated light, or Haze value as in JIS-K7105 or JIS-K7136. These values are measured by adhering a sample to an integrating sphere and irradiating light from the direction of the normal line of the sample surface under conditions preventing light leakage; however, it is not assumed that measurements are taken while freely changing the incident angle. That is, there is no publicly known method to evaluate the incident angle dependence property of an anisotropic scattering adhesive member. Therefore, in the present invention, as shown in FIG. 3, evaluation of the incident angle dependence property of the amount of linear transmitted light is performed by arranging a sample between a light source (not shown in the figure) and a light receiving device 4, and by measuring the amount of light which is transmitted straight through the sample and enters into the light receiving device 4 while changing the angle of the sample by revolving around line L or line M perpendicular to the line L on the surface of the sample. As a device used specifically, a commercially available hazemeter, bending photometer, and spectrophotometer in which a rotatable sample holder is arranged between the light source and the light receiving part, may be mentioned. Although the value of the light amounts obtained by these measuring devices are relative values, the measured results shown in FIG. 5 were obtained as the incident angle dependence property of the amount of linear transmitted light. If a vertical axis is expressed by a haze which is an indicator of scattering property, an inverted graph of the graph of FIG. 5 may be obtained.

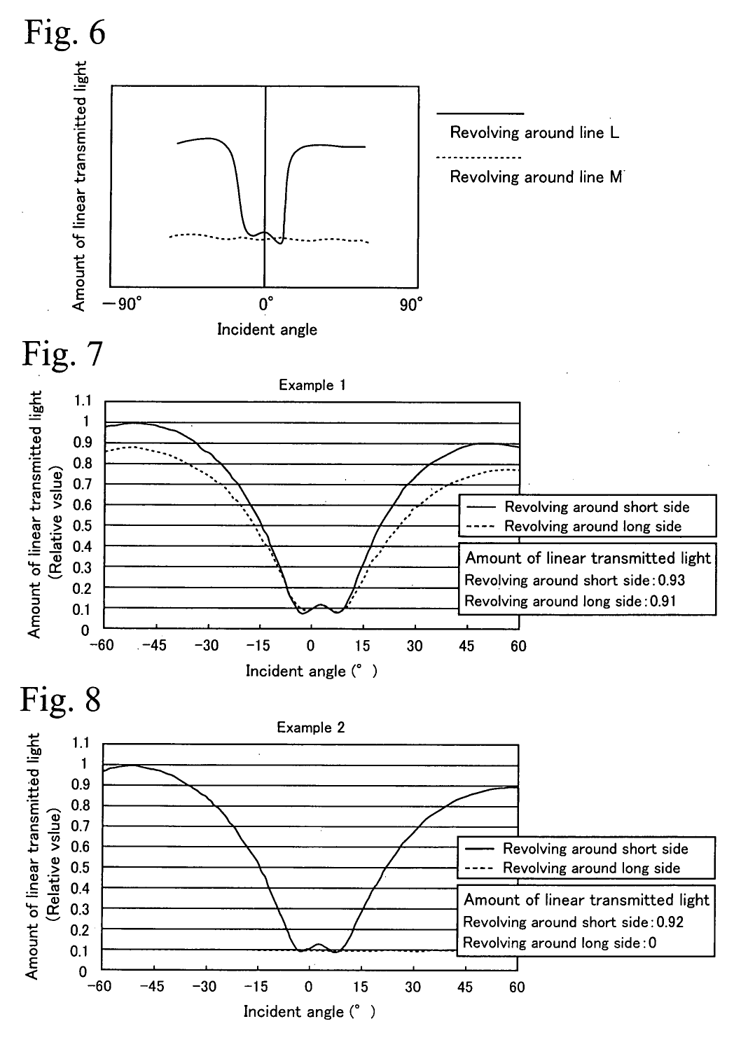

In the measurement method shown in FIG. 3, the anisotropic scattering adhesive member having the structure of FIG. 1 exhibits the incident angle dependence property of the amount of linear transmitted light as shown in FIG. 5 both in the case in which the sample is rotated around line A-A and in the case in which the sample is rotated around line B-B. The anisotropic scattering adhesive member having the structure of FIG. 2A, when the line B-B is set to line L of FIG. 3 and the line A-A is set to line M of FIG. 3, exhibits the incident angle dependence property of the amount of linear transmitted light as shown by a solid line in FIG. 6 in the case in which the light controlling plate is rotated around the line B-B, and does not exhibit or exhibits in a different manner the incident angle dependence property of the amount of linear transmitted light as shown by a dotted line in FIG. 6 in the case in which the light controlling plate is rotated around the line A-A.

As an embodiment of the anisotropic scattering adhesive member of the present invention, a single use anisotropic scattering adhesive member, a structure in which the anisotropic scattering adhesive member is layered on a transparent substrate, and a structure in which transparent substrates are layered on both sides of the anisotropic scattering adhesive member, can be provided. For the transparent substrate, it is desirable that the transparency be high, desirably a full-spectrum transmission (JIS K7361-1) of not less than 80%, more desirably not less than 85%, and most desirably not less than 90%, and furthermore, desirably, a Haze value (JIS K7136) of not more than 3.0, more desirably not more than 1.0, and most desirably not more than 0.5. A transparent plastic film, glass plate or the like can be used, and in particular, the plastic film is desirable from the viewpoints of thinness, portability, shatterproof properties, and productivity. Specifically, polyethylene terephthalate (PET), polyethylene naphthalate (PEN), triacetylcellulose (TAC), polycarbonate (PC), polyarylate, polyimide (PI), aromatic polyamide, polysulfone (PS), polyethersulfone (PES), cellophane, polyethylene (PE), polypropylene (PP), polyvinylalcohol (PVA), cycloolefm resin or the like can be mentioned, and these may be used alone or plurally in a mixture, or be layered. The thickness of the substrate is in a range from 1 μm to 5 mm from the viewpoints of purpose and productivity, desirably 10 to 500 μm, and more desirably 50 to 150 μm.

The adhesive strength when peeled at 180 degrees of the anisotropic scattering adhesive member of the present invention is desirably in a range from 1 to 30 N/25 mm, more desirably from 3 to 20 N/25 mm, and most desirably from 5 to 15 N/25 mm. If the adhesive strength is less than 1 N/25 mm, durability when used, particularly for displays, is low. On the other hand, if the adhesive strength is more than 30 N/25 mm, although the durability for use of the displays is improved, workability is deteriorated such that adjustment (re-bonding) becomes difficult when the member is bonded to other optical films or the like.

Measurement of the adhesive strength when peeled at 180 degrees was performed according to JIS-Z0237. The solvent used for washing was ethanol. Test pieces were made by cutting the anisotropic scattering adhesive member into 25 mm×250 mm pieces. Edges of a test piece were bonded to the edges of a test plate so that an area of 25 mm×120 mm of the piece was bonded, and the test piece was pressed to the test plate by reciprocating a 2 kg roller twice at 20 mm/s. After 30 minutes passed and 24 hours passed, the test piece was pulled in a direction of 180 degrees to measure adhesive strength.

The resin layer constructing the anisotropic scattering adhesive member of the present invention is a photo-curable resin composition in which a composition containing a photo-curable compound is cured, and fine structures on the order of microns having different refractive indexes are formed in the anisotropic scattering adhesive member by light irradiation. This mechanism yields the incident angle dependence property of the present invention. Therefore, in the photo-curable resin composition, combination of different refractive indexes after photo-curing is required, and it is desirable that phase separation occur in the polymers or the like having mutually different refractive indexes after photo-curing.

It should be noted that “combination of different refractive indexes after photo-curing” do not mean a limitation that the photo-curable resin composition includes plural resins having different refractive indexes after curing. For example, even if the photo-curable resin composition includes one kind of resin, by curing under conditions in which there is a concentration gradient of the resin during photo-curing, areas having mutually different refractive indexes according to difference of resin density after curing can be formed.

To yield the adhesive property of the anisotropic scattering adhesive member of the present invention at room temperature, the glass transition temperature (TG) of the resin layer is desirably in a range from −85° C. to 0° C. In the case in which the glass transition temperature is more than 0° C., a hard plastic film which does not have adhesive property is formed, and it may become difficult to perform the present invention. In the case in which the glass transition temperature is less than −85° C., the resin layer may not be a material easily handled and selectable any more.

As the primary and secondary resin components used in the anisotropic scattering adhesive member of the present invention, the following compounds can be mentioned.

As the primary resin component, polyfunctional monomers such as trimethylolpropane triacrylate, ethoxide trimethylolpropane triacrylate, pentaerythritol triacrylate, pentaerythritol tetraacrylate, and pentaerythritol hexaacrylate; acrylic oligomers such as epoxy acrylate, urethane acrylate, polyester acrylate, polyether acrylate, polybutadiene acrylate, and silicon acrylate having the above monomer component at the terminus can be mentioned. They can be used alone or in combination.

As the secondary resin component, one having phenyl group in the molecule or halides can be mentioned. For example, phenoxyethyl acrylate, EO added diacrylate of bisphenol A, 2,2-bis[4-(acryloxydiethoxy)phenyl]propane, 2,2-bis[4-(methacryloxyethoxy)phenyl]propane, tribromophenyl acrylate, EO denatured tribromophenyl acrylate or the like can be mentioned. They can be used alone or in combination.

As a photopolymerization initiator, α-hydroxyketone type photopolymerization initiator, α-aminoketone type photopolymerization initiator, benzylketal type photopolymerization initiator, acylphosphineoxide type photopolymerization initiator, benzophenone type photopolymerization initiator, thioxanthone type photopolymerization initiator or the like can be mentioned. These compounds can be used alone or in plurally mixed state. A hydrogen-abstraction type photopolymerization initiator such as benzophenone type or thioxanthone type must be used mixed with a photopolymerization initiating auxiliary agent such as amine type compounds such as N-methyldiethanol amine or 4,4′-bisdiethylaminobenzophenone or the like.

In the resin layer of the present invention, in the case in which the primary resin component is cured, there is no difference in refractive indexes by concentration gradient or the like during the photo-curing, or in the case in which the refractive index of the primary resin component after curing is the same as the refractive index of other resin contained in the photo-curable resin composition after curing, it is desirable that the secondary resin component be added.

Except for the constitution element mentioned above, a monofunctional monomer can be contained for viscosity control.

The production method of the anisotropic scattering adhesive member of the present invention is not limited in particular as long as the photo-curable resin composition is cured by photo irradiation, and for example, the above-mentioned photo-curable resin composition may be made into the shape of a sheet and a light beam may be irradiated from a certain direction to cure the composition.

For the purpose of promoting curing of the photo-curable resin composition or controlling the extent of the incident angle dependence property during the photo irradiating, one or both sides of the composition formed into the shape of a sheet can be covered with a transparent and flexible sheet. Alternatively, a mask having a specific translucent pattern can be used as the flexible sheet. Furthermore, for the same purpose, the composition formed into the shape of a sheet can be heated before and after photo irradiation.

As a method to form the photo-curable resin composition into sheet-shaped on a substrate, a conventional coating method or printing method can be performed. Practically, a coating method such as air doctor coating, bar coating, blade coating, knife coating, reverse coating, transfer roll coating, gravure roll coating, kiss coating, cast coating, spray coating, slot orifice coating, calender coating, dam coating, dip coating, dye coating or the like; intaglio printing such as gravure printing or the like, and stencil printing such as screen printing can be used. In the case in which the composition has low viscosity, a dam having a certain height is arranged around the substrate, and the composition can be cast into the area surrounded by the dam.

As a light source to perform irradiation on the sheet of the photo-curable resin composition, an ultraviolet light generating light source of short arc is usually used, and practically, a high pressure mercury lamp, low pressure mercury lamp, metal halide lamp, xenon lamp or the like can be used.

The shape of the fine structure formed by photo irradiation varies depending on the shape of an emission surface, and plate-shaped fine structures are formed by a light source having an emission surface with a bar-shape, whereas on the other hand, if a collimated light source is used in exposure of a resist, pillar-shaped fine structures are formed. The latter is more desirable considering the use of the present invention. Furthermore, in the case in which the pillar-shaped fine structures is formed, if the size of the anisotropic scattering adhesive member is small, it is possible to perform irradiation from a substantial distance using an ultraviolet light spot light source.

The light source which emits to a sheet-shaped photo-curable resin composition is required to have a wavelength which can harden the photo-curable compound. Usually, a light mainly having a wavelength of 365 nm from a mercury lamp is used. To produce the anisotropic scattering adhesive member of the present invention using the wavelength range illumination intensity is desirably in a range from 0.01 to 100 mW/cm², and more desirably in a range from 0.1 to 20 mW/cm². If the illumination intensity is less than 0.01 mW/cm², it will take a long time to harden, and production efficiency will decrease, whereas on the other hand, if the illumination intensity is more than 100 mW/cm², curing of the photo-curable compound is too rapid and the structure of the present invention cannot be obtained, and the target incident angle dependence property cannot be exhibited.

In the photo-curable resin composition of the anisotropic scattering adhesive member of the present invention, solvent can be used to improve coating suitability. The viscosity of the composition is reduced by using the solvent, and handling during coating becomes easier. As such a solvent, alcohols such as methanol, ethanol, 1-propanol, 2-propanol or butanol, glycols such as ethylene glycol, propylene glycol or hexylene glycol, glycol ethers such as ethyl cellosolve, butyl cellosolve, ethyl carbitol, butyl carbitol, diethyl cellosolve or diethyl carbitol, ketones such as acetone, methylethyl ketone or methylisobutyl ketone, esters such as methyl acetate, ethyl acetate, propyl acetate or butyl acetate, aromatic hydrocarbons such as benzene, toluene or xylene, nitrogen-containing kinds such as N-methyl pyrrolidone or dimethyl formamide, hydrocarbon halides such as chloroform, chloromethylene or trichloroethylene can be used, and this is not particularly limited. The above-mentioned solvents may be used alone or in mixture.

It should be noted that solvent removing process by heating, drying, or the like is required before curing of the composition by photo irradiation if the solvent is used in the photo-curing resin composition.

### EXAMPLES

### Example 1

A division wall having a height of 0.3 mm was formed around an edge of a PET film (trade name: A4300, produced by Toyobo) having a size of 76×26 mm and a thickness of 75 μm with a curable resin using a dispenser. The following photo-curable resin composition was dropped in the area surrounded by the wall, and this was covered by another PET film.
Ultraviolet curable type adhesive containing primary resin component (Trade name: RAYTACK-10, produced by Jujo Chemical) 100 parts by weight
Phenoxyethyl acrylate which is a secondary resin component (Trade name: PO-A, produced by Kyoei Kagaku Kogyo) 11 parts by weight
   Ultraviolet light having an irradiation intensity of 8 mW/cm² was emitted from an epi-irradiation unit with a UV spot light source (Trade name: L2859-01, produced by Hamamatsu Photonics) vertically to the liquid membrane having a thickness of 0.3 mm placed between the PET films for 15 minutes. Removing the PET films on both surfaces, the anisotropic scattering adhesive member of Example 1 whose TG value by DSC method was −27° C. and adhesive strength when peeled at 180 degrees was 19 N/25 mm and in which a large number of pillar-shaped fine areas shown in FIG. 1 were formed, was obtained.

### Example 2

Ultraviolet light having an irradiation intensity similar to that of the Example 1 was irradiated from a linear UV source (Trade name: Handy UV device HUV-100, produced by Japan UV Machine) having an emission length of 125 mm arranged in a direction perpendicular to the long side of the PET film, and vertically to the photo-curable resin composition similar to that of the Example 1 placed between the PET films. The anisotropic scattering adhesive member of Example 2 whose TG value by DSC method was −27° C. and adhesive strength when peeled at 180 degrees was 19 N/25 mm and in which plate-shaped areas having mutually different refractive indexes shown in FIG. 2A were formed, was obtained.

### Example 3

Ultraviolet light having an irradiation intensity of 30 mW/cm² was emitted from an epi-irradiation unit with a UV spot light source (Trade name: L2859-01, produced by Hamamatsu Photonics) vertically to the photo-curable resin composition similar to that of the Example 1 placed between the PET films for 5 minutes. Removing the PET films on both surfaces, the anisotropic scattering adhesive member of Example 3 whose TG value by the DSC method was −27° C. and adhesive strength when peeled at 180 degrees was 19 N/25 mm and in which a large number of pillar-shaped fine areas shown in FIG. 1 were formed, was obtained.

### Comparative Example 1

A division wall having a height of 0.3 mm was formed around an edge of a PET film (trade name: A4300, produced by Toyobo) having a size of 76×26 mm and a thickness of 75 μm with a curable resin using a dispenser. The following photo-curable resin composition was dropped in the area surrounded by the wall, and this was covered by another PET film.
2-(perfluorooctyl)-ethyl acrylate (Trade name: Light Acrylate FA-108, produced by Kyoei Kagaku Kogyo) 50 parts by weight
1,9-nonandiol diacrylate (Trade name: Light Acrylate 1.9ND-A, produced by Kyoei Kagaku Kogyo) 50 parts by weight
2-hydroxy-2-methyl-1-phenylpropan-1-one (Trade name: Darocure 1173. produced by Ciba Specialty Chemicals) 4 part by weight
   Ultraviolet light having an irradiation intensity of 8 mW/cm² was irradiated from an epi-irradiation unit with a UV spot light source (Trade name: L2859-01, produced by Hamamatsu Photonics) vertically to the liquid membrane having a thickness of 0.3 mm placed between the PET films for 15 minutes. Removing the PET films on both surfaces, the light scattering film of Comparative Example 1 whose TG value by DSC method was about 70° C. and in which a large number of pillar-shaped fine areas shown in FIG. 1 were formed, was obtained.

### Comparative Example 2

Ultraviolet light having an irradiation intensity similar to that of the Comparative Example 1 was irradiated from a linear UV source (Trade name: Handy UV device HUV-100, produced by Japan UV Machine) having an emission length of 125 mm arranged in a direction perpendicular to the long side of the PET film, and vertically to the photo-curable resin composition similar to that of the Comparative Example 1 placed between the PET films. The light controlling plate of Comparative Example 2 whose TG value by DSC method was 70° C. and in which plate-shaped areas having mutually different refractive indexes shown in FIG. 2A were formed, was obtained.

Using a goniophotometer (Trade name: GP-5, produced by Murakami Color Research Laboratory), a light receiving part was fixed at a position to receive straight traveling light from a light source, and the anisotropic scattering adhesive members of Examples 1 to 3, the light scattering film of Comparative Example 1 and the light controlling plate of Comparative Example 2 were set in a sample holder between the light source and the light receiving part. As shown in FIG. 3, the short edge of the sample was defined as a revolving axis (L), the sample was revolved and the amount of linear transmitted light corresponding to each incident angle was measured, and this test is called “revolving around the short side”. Next, the sample was removed from the sample holder, the sample was revolved 90 degrees in the surface and the sample was again set to the holder. This time, the amount of linear transmitted light when revolving around the long edge of the sample, that is, a revolving axis (M), was measured and this test is called “revolving around the long side”.

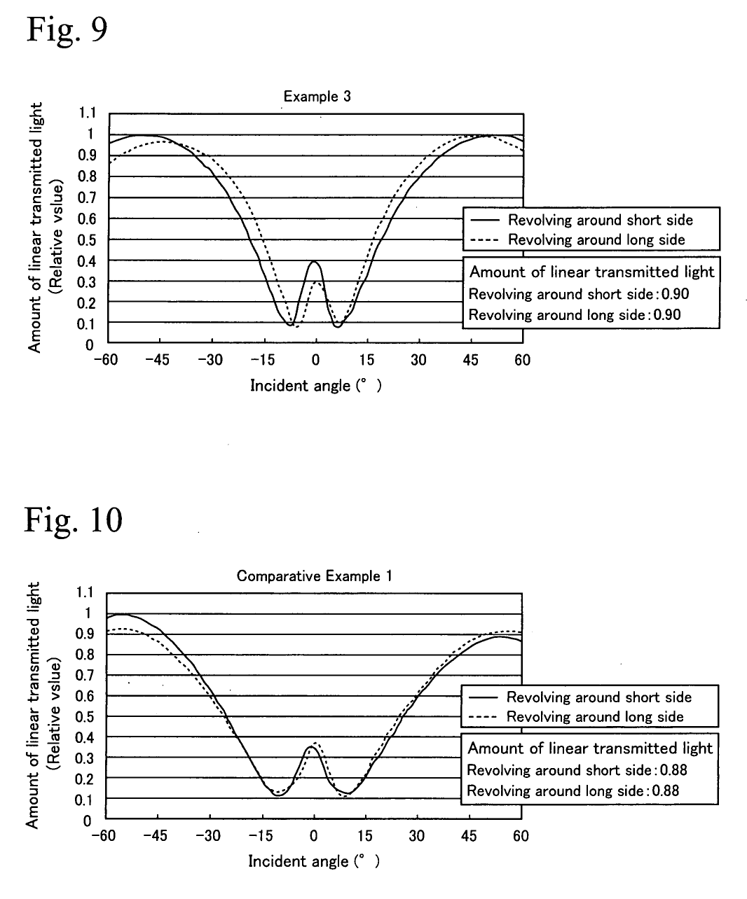

Regarding the anisotropic scattering adhesive members of Examples 1 and 3 and the light scattering film of Comparative Example 1, the relationship of the incident angle and the amount of the linear transmitted light measured concerning the two revolving axes of the short side and the long side, is shown in FIGS. 7, 9 and 10. In all these figures, the changed rate of the amount of linear transmitted light (difference between maximum value and minimum value of the amount of linear transmitted light) exhibits a deep valley of about 0.8 to 0.9, and the graph is almost bilaterally symmetric.

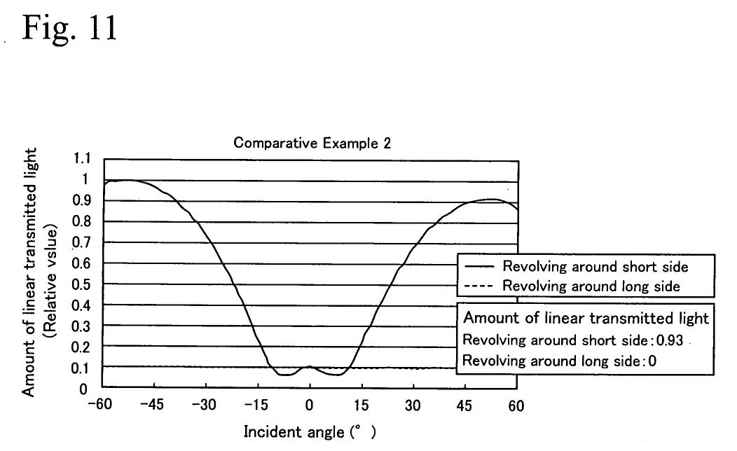

Regarding the anisotropic scattering adhesive member of Example 2 and the light controlling plate of Comparative Example 2, the relationship of the incident angle and the amount of the linear transmitted light measured concerning the two revolving axes of the short side and the long side, is shown in FIGS. 8 and 11. In all these figures, the changed rate of the amount of linear transmitted light during revolving around the short side exhibits a deep valley of about 0.8 to 0.9, and the graph is almost bilaterally symmetric. However, there was no great change exhibited in the amount of linear transmitted light during revolving around the long side, and the changed rate was not more than 0.1.

The anisotropic scattering adhesive members of Examples 1 to 3 exhibited adhesion property as mentioned above; however, the light scattering film and the light controlling plate of Comparative Examples 1 and 2 did not exhibit adhesion property, therefore, the adhesive strength when peeled at 180 degrees could not be measured.

As explained above, by the present invention, an anisotropic scattering adhesive member having a large change in the rate of the amount of linear transmitted light depending on the incident angle of incident light, that is, having a large incident angle dependence property, and also having an adhesion property, can be provided.

What is claimed is:

1. An anisotropic scattering adhesive member comprising a resin layer formed by curing a photo-curable resin composition containing at least one of a monomer and an oligomer as a primary resin component and having a photo-polymerizable functional group, wherein the glass transition temperature after the curing of the resin layer is in a range from −85 to 0° C., and wherein the amount of linear transmitted light corresponding to an incident light transmitted through the resin layer varies depending on the incident angle of the incident light.

2. The anisotropic scattering adhesive member according to claim 1, wherein refractive indexes of mutually adjacent cured areas formed in the resin layer are different.

3. The anisotropic scattering adhesive member according to claim 1, wherein the resin layer comprises a matrix and specific cured areas formed in the matrix, and wherein the refractive index of the matrix and the refractive index of the specific cured areas are different from each other.

4. The anisotropic scattering adhesive member according to claim 1, wherein a high-refractive index monomer (secondary resin component) having a photo-polymerizable functional group is added to the photo-curable resin composition.

5. The anisotropic scattering adhesive member according to claim 1, wherein an adhesive strength of the resin layer when peeled at 180 degrees is in a range from 1 to 30 N/25 mm.

6. The anisotropic scattering adhesive member according to claim 1, wherein the amount of linear transmitted light has a scattering center axis.

7. The anisotropic scattering adhesive member according to claim 1, wherein a transparent substrate is layered on at least one side of the resin layer.
